(19) United States
(12) Patent Application Publication
(10) Pub. No.: US 2025/0379491 A1
(43) Pub. Date: Dec. 11, 2025

(54) ELECTRIC ACTUATOR

(71) Applicants: Nidec Taiwan Corporation, Taipei City (TW); NIDEC CORPORATION, Kyoto (JP)

(72) Inventors: Huu-Tich NGO, Taipei City (TW); Guo-Jhih YAN, Taipei City (TW); Keng-Chang WU, Taipei City (TW)

(21) Appl. No.: 18/836,627

(22) PCT Filed: Feb. 16, 2022
(86) PCT No.: PCT/JP2022/006078

§ 371 Date: Jan. 22, 2025

(51) Int. Cl. H02K 7/102

(52) U.S. Cl. CPC H02K 7/1023

(57) ABSTRACT

An electric actuator includes a motor portion including a rotor rotatable about a motor shaft and a stator opposing the rotor, a reduction gear to decelerate and output rotation of the rotor, a brake to brake rotation of the rotor, a position detector to detect a position change of the rotor, and a cover that accommodates the motor portion. The reduction gear, the brake, the motor portion, and the position detector are sequentially arranged in an axial direction from one side in the axial direction. The brake includes a first brake portion that includes a magnetic material; and a second brake portion that rotates in synchronization with the rotor, is in contact with the first brake portion at a braking position, and is in non-contact with the first brake portion at the non-braking position, and a solenoid.

### CROSS REFERENCE TO RELATED APPLICATION

This is a U.S. national stage of International Application No. PCT/JP2022/006078, with an international filing date of Feb. 16, 2022, the entire contents of which is hereby incorporated by reference herein.

### FIELD OF THE INVENTION

The present disclosure relates to electric actuators.

### BACKGROUND

There is an electric actuator connected to equipment such as a robot arm. In the electric actuator disclosed in U.S. Pat. No. 9,579,805, a position detector that detects the rotational position of the motor portion and a brake device that stops the rotation of the motor portion in order to ensure the safety of equipment and a system in operation are used.

In the electric actuator described in U.S. Pat. No. 9,579,805, since the brake device has a pin member that moves in the axial direction of the motor shaft, and a space for accommodating the brake device is separately provided, there is a problem that the dimension in the axial direction is particularly long, leading to an increase in size of the electric actuator.

### SUMMARY

The present disclosure has been made in consideration of the above points, and example embodiments of the present disclosure provide compact electric actuators.

An example embodiment of an electric actuator of the present disclosure includes a motor portion that includes a rotor rotatable about a motor shaft extending in an axial direction, and a stator opposing the rotor with a gap interposed therebetween, a reduction gear to decelerate and output rotation of the rotor, a brake to brake rotation of the rotor, a position detector to detect a position change of the rotor, and a cover that is located on one side of the motor portion in the axial direction and accommodates the motor portion inside. The reduction gear, the brake, the motor portion, and the position detector are sequentially arranged in the axial direction from one side in the axial direction. The brake includes a first brake portion that includes a magnetic material located on one side in the axial direction of the rotor, the first brake portion being movable in the axial direction between a braking position for braking rotation of the rotor and a non-braking position away from the braking position toward one side in the axial direction, a second brake portion that rotates in synchronization with the rotor, is in contact with the first brake portion at the braking position, and is in non-contact with the first brake portion at the non-braking position, and a solenoid that switches a position of the first brake portion between the braking position and the non-braking position according to an energized state. The brake device is accommodated inside the cover.

According to an example embodiment of the present disclosure, a compact electric actuator can be provided.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating an electric actuator of an example embodiment of the present disclosure.

FIG. 2 is an exploded perspective view illustrating a brake device and a cover portion of a first example embodiment.

FIG. 3 is an enlarged cross-sectional view of the periphery of the brake device in which a first brake portion is at a non-braking position.

FIG. 4 is an enlarged cross-sectional view of the periphery of the brake device in which the first brake portion is at the braking position.

FIG. 5 is an external perspective view of the first brake portion and the second brake portion at the braking position.

FIG. 6 is an exploded perspective view illustrating a brake device and a cover portion of a second example embodiment.

FIG. 7 is an external perspective view of the first brake portion and the second brake portion at a braking position according to the second example embodiment.

FIG. 8 is an exploded perspective view illustrating a brake device and a cover portion of a third example embodiment.

FIG. 9 is an external perspective view of a first brake portion and a second brake portion at a braking position according to the third example embodiment.

FIG. 10 is an exploded perspective view illustrating a brake device and a cover portion of a fourth example embodiment.

FIG. 11 is an external perspective view of the first brake portion in the fourth example embodiment.

FIG. 12 is an external perspective view of the second brake portion in the fourth example embodiment.

FIG. 13 is an enlarged cross-sectional view of the periphery of the brake device in which the first brake portion is at the non-braking position.

FIG. 14 is an enlarged cross-sectional view of the periphery of the brake device in which the first brake portion is at the braking position.

### DETAILED DESCRIPTION

Hereinafter, an electric actuator according to an example embodiment of the present disclosure will be described with reference to the drawings. Note that the scope of the present disclosure is not limited to the example embodiments described below, but includes any modification thereof within the scope of the technical idea of the present disclosure. Also note that scales, numbers, and the like of members or portions illustrated in the following drawings may differ from those of actual members or portions, for the sake of easier understanding of the members or portions.

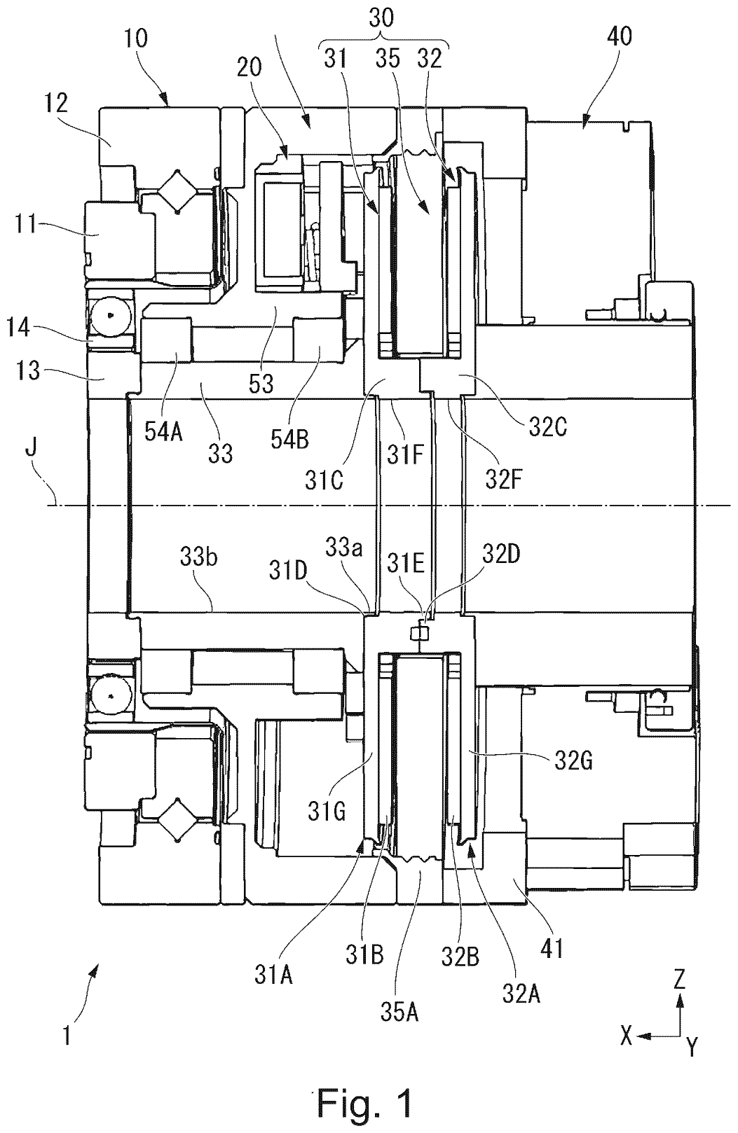

The drawings illustrate an XYZ coordinate system as a three-dimensional orthogonal coordinate system as appropriate. In an XYZ coordinate system, the X-axis direction is a direction parallel to a central axis J illustrated in FIG. 1 and is referred to as an axial direction. The Z-axis direction is a direction orthogonal to the X-axis direction and is an up-down direction in FIG. 1. A Y-axis direction is a direction orthogonal to both the X-axis direction and the Z-axis direction.

In the present specification, the +X side in the X-axis direction, which is one side in the axial direction and the front side of the electric actuator, is referred to as “left side”, and the −X side in the X-axis direction, which is the other side in the axial direction and the rear side of the electric actuator, is referred to as “right side”. The upper side (+Z side) in FIG. 1 in the Z-axis direction is simply referred to as an “upper side”, and the lower side (−Z side) is simply referred to as a “lower side”. Note that the front-rear direction and the up-down direction do not indicate a positional relationship and a direction when incorporated in an actual equipment. In addition, a direction (X-axis direction) parallel to the central axis J may be simply referred to as an “axial direction”, a radial direction centered on the central axis J may be simply referred to as a “radial direction”, and a circumferential direction centered on the central axis J may be simply referred to as a “circumferential direction”.

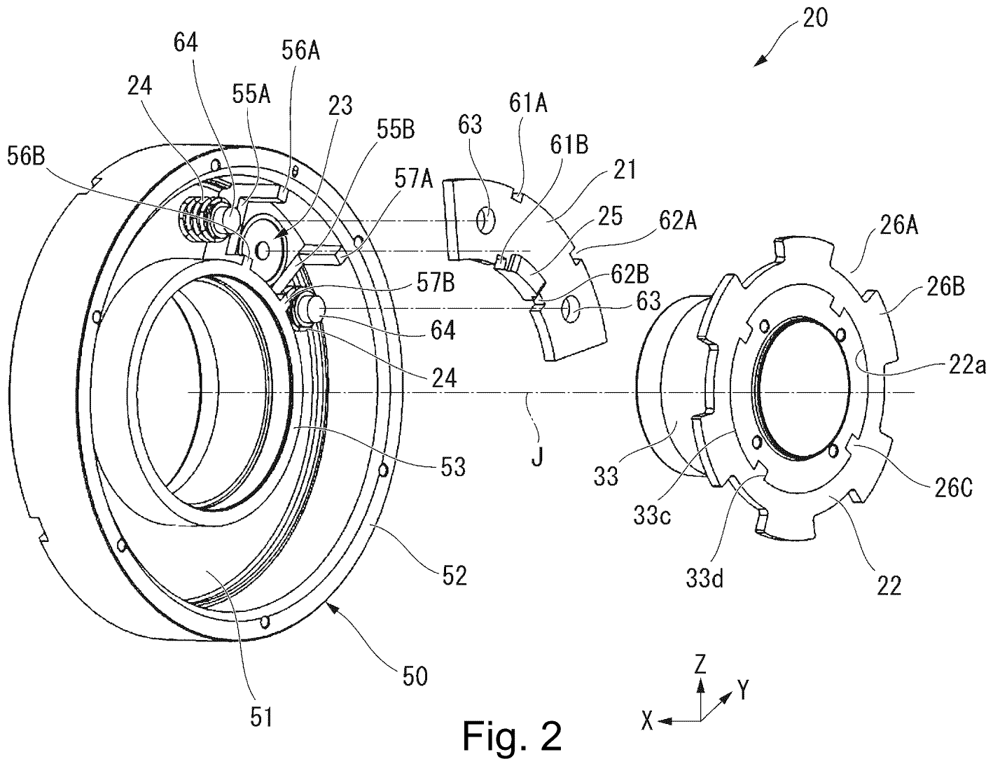

An electric actuator 1 illustrated in FIGS. 1 and 2 is, for example, an electric actuator mounted on a vehicle, a robot arm, or the like. As illustrated in FIG. 1, the electric actuator 1 includes a motor portion 30, a reduction gear 10, a brake device 20, a position detector 40, and a cover portion 50. The reduction gear 10, the brake device 20, the motor portion 30, and the position detector 40 are sequentially arranged in the axial direction from the left side in the axial direction.

The central axis of the motor portion 30 is the central axis J. The motor portion 30 includes rotors 31 and 32, a stator 35, and a motor shaft 33. The motor shaft 33 has a tubular shape extending around the central axis J. The motor shaft 33 has an annular protrusion 33a and a through hole 33b. The annular protrusion 33a is an annular protrusion protruding to the right side in the axial direction of the motor shaft 33. The annular protrusion 33a is located at the radially inner end of the motor shaft 33. The through hole 33b penetrates the motor shaft 33 in the axial direction.

The rotor 31 is rotatable about the motor shaft 33. The rotor 31 is located on the right side in the axial direction of the motor shaft 33. The rotor 31 includes a rotor core 31A and a rotor magnet 31B. The rotor core 31A has an annular portion 31C and a disk portion 31G. The annular portion 31C has a tubular shape extending around the central axis J. The annular portion 31C has a recess 31D, an annular protrusion 31E, and a through hole 31F. The through hole 31F penetrates the annular portion 31C in the axial direction. The inner diameter of the through hole 31F is the same as the inner diameter of the through hole 33b. The recess 31D is recessed from the left end in the axial direction of the annular portion 31C to the right side in the axial direction. The recess 31D is located at the radially inner end of the annular portion 31C. The recess 31D is fitted to the annular protrusion 33a from the outside in the radial direction. The recess 31D is fitted to the annular protrusion 33a from the outside in the radial direction, whereby the rotor core 31A is positioned with the motor shaft 33 in the radial direction. The disk portion 31G extends radially outward from the outer peripheral surface of the annular portion 31C.

The rotor magnet 31B is provided on the right side in the axial direction of the disk portion 31G in the rotor core 31A. As an example, sixteen rotor magnets 31B are provided at intervals in the circumferential direction.

The rotor 32 is rotatable about the motor shaft 33. The rotor 32 is located on the right side in the axial direction with respect to the rotor 31. The rotor 32 includes a rotor core 32A and a rotor magnet 32B. The rotor core 32A has an annular portion 32C and a disk portion 32G. The annular portion 32C has a tubular shape extending around the central axis J. The annular portion 32C has a recess 32D and a through hole 31F. A through hole 32F penetrates the annular portion 32C in the axial direction. The inner diameter of the through hole 32F is the same as the inner diameters of the through hole 33b and the through hole 31F. The recess 32D is recessed from the right end in the axial direction of the annular portion 32C to the left side in the axial direction. The recess 32D is located at the radially inner end of the annular portion 32C. The recess 32D is fitted to the annular protrusion 31E from the outside in the radial direction. The recess 32D is fitted to the annular protrusion 31E from the outside in the radial direction, whereby the rotor core 32A is positioned in the radial direction with respect to the motor shaft 33 and the rotor core 31A.

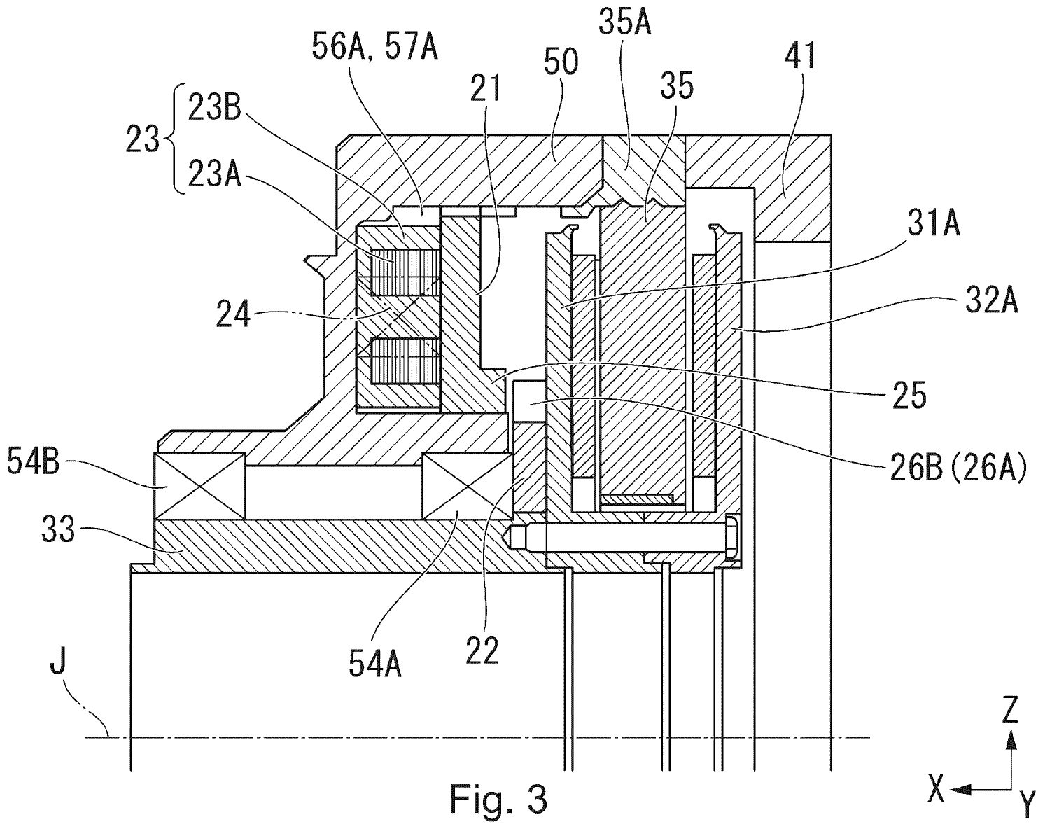

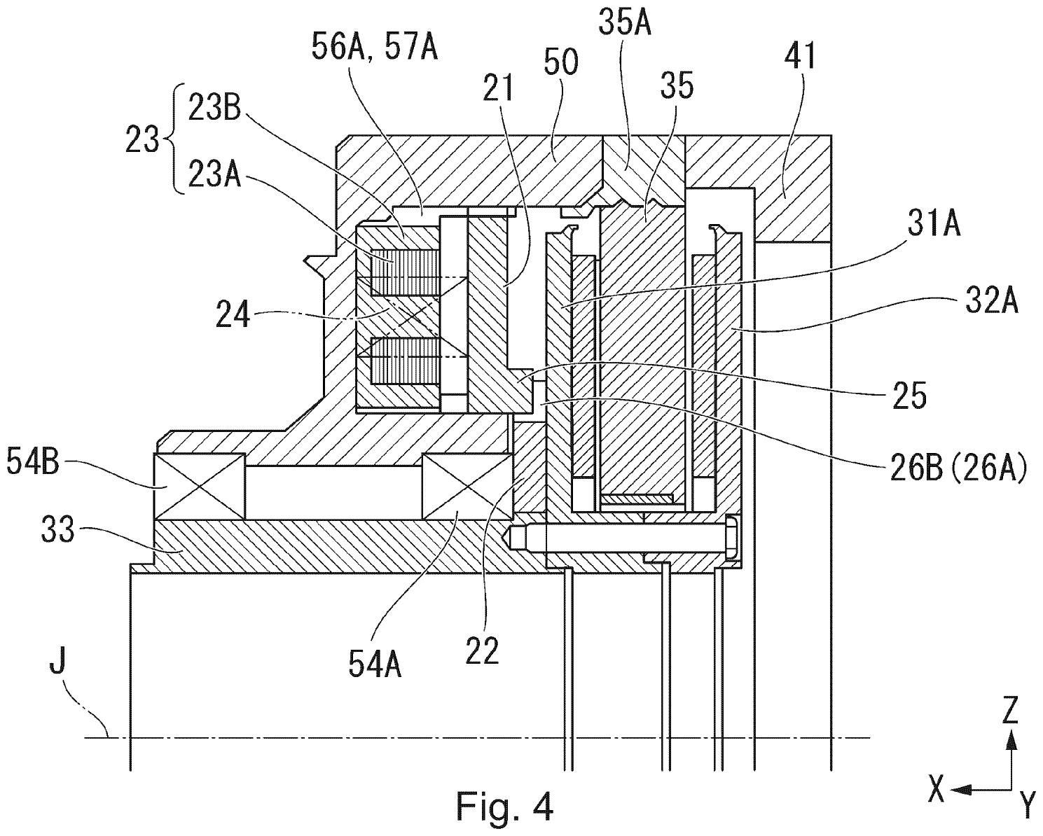

The disk portion 32G extends radially outward from the outer peripheral surface of the annular portion 31C. The rotor core 31A and the rotor core 32A are screwed and fixed to the motor shaft 33 from the right side in the axial direction in the annular portion 31C and the annular portion 32C (see FIGS. 3 and 4). In practice, out of the screwed rotor core 31A and rotor core 32A, the rotor core 31A is screwed to the motor shaft 33, whereby the rotor core 31A and the rotor core 32A are fixed to the motor shaft 33. However, in the following description including the drawings, in order to facilitate understanding, a configuration in which a screw member integrates the rotor core 31A, the rotor core 32A, and the motor shaft 33 will be described. The rotor core 31A, the rotor core 32A, and the motor shaft 33 that are screwed and fixed to the motor shaft 33 in the annular portion 31C and the annular portion 32C rotate integrally.

The rotor magnet 32B is provided on the left side in the axial direction of the disk portion 32G in the rotor core 32A. As an example, sixteen rotor magnets 32B are provided at intervals in the circumferential direction. The rotor magnet 32B is disposed away from the right side in the axial direction of the rotor magnet 31B.

The stator 35 is provided on the radially inner side of a stator cover 35A. The stator cover 35A is fixed to the cover portion 50 from the right side in the axial direction. The stator 35 is located to oppose the right side of the rotor magnet 31B in the axial direction of the rotor magnet 31B in the rotor 31 with a gap interposed therebetween. The stator 35 is located to oppose the left side of the rotor magnet 32B in the axial direction of the rotor magnet 32B in the rotor 32 with a gap interposed therebetween. The stator 35 axially faces the rotor magnet 31B in the rotor 31 and the rotor magnet 32B in the rotor 32 with a gap interposed therebetween. That is, the motor portion 30 is an axial flux-type motor (AFM). Since the motor portion 30 is an axial flux-type motor, the motor portion can be made thin and has high torque in the axial direction, and the electric actuator 1 can be downsized in the radial direction.

The reduction gear 10 decelerates and outputs the rotation of the rotors 31 and 32. The reduction gear 10 includes an output flange 11 and an internal 12. The internal 12 is fixed to the cover portion 50 from the left side in the axial direction. The output flange 11 is disposed radially inside the internal 12. The output flange 11 is rotatably supported by the motor shaft 33 via a cam ring 13 and a ball bearing 14. The cam ring 13 is screwed and fixed to the motor shaft 33 from the left side in the axial direction. The output flange 11 revolves orbitally with respect to the internal 12 along with the rotation of the motor shaft 33 and rotates at a low speed at the same time, and rotates at a speed lower than that of the motor shaft 33. The output flange 11 transmits the decelerated rotation to the connected equipment.

The position detector 40 detects a position change of the rotor 32. The position detector 40 is fixed to the right side in the axial direction of the cover portion 50 via the stator cover 35A and an adapter 41.

The cover portion 50 is located on the left side in the axial direction of the motor portion 30. The cover portion 50 accommodates the motor portion 30 therein. As illustrated in FIG. 2, the cover portion 50 includes a peripheral wall portion 51, an outer peripheral wall 52, and an inner peripheral wall 53. The peripheral wall portion 51 has an annular shape that is orthogonal to the axial direction and extends in the circumferential direction around the axial direction. The outer peripheral wall 52 has a tubular shape extending from the outer edge of the peripheral wall portion 51 to the right side in the axial direction over the entire circumference. The inner peripheral wall 53 has a tubular shape extending from the inner edge of the peripheral wall portion 51 to the right side in the axial direction over the entire circumference. The cover portion 50 accommodates the motor portion 30 in a space surrounded by the peripheral wall portion 51, the outer peripheral wall 52, and the inner peripheral wall 53. As illustrated in FIG. 1, the cover portion 50 is supported by the motor shaft 33 via ball bearings 54A and 54B fitted to the inner peripheral wall 53.

The cover portion 50 includes holding walls 55A and 55B, guide walls 56A and 56B, and guide walls 57A and 57B. The holding walls 55A and 55B each have a rib shape protruding to the right side in the axial direction from the peripheral wall portion 51. The holding walls 55A and 55B each extend in the radial direction. The holding walls 55A and 55B each connect the outer peripheral wall 52 and the inner peripheral wall 53. The holding wall 55A and the holding wall 55B are arranged at intervals in the circumferential direction.

The guide wall 56A has a rectangular cross section, and protrudes radially inward from the inner peripheral surface of the outer peripheral wall 52 at a position in the circumferential direction of the holding wall 55A. The guide wall 56B has a rectangular cross section, and protrudes radially outward from the outer peripheral surface of the inner peripheral wall 53 at a position in the circumferential direction of the holding wall 55A. The guide wall 57A has a rectangular cross section, and protrudes radially inward from the inner peripheral surface of the outer peripheral wall 52 at a position in the circumferential direction of the holding wall 55B. The guide wall 57B has a rectangular cross section, and protrudes radially outward from the outer peripheral surface of the inner peripheral wall 53 at a position in the circumferential direction of the holding wall 55B.

The brake device 20 brakes the rotation of the rotors 31 and 32. As illustrated in FIG. 2, the brake device 20 according to the first example embodiment includes a first brake portion 21, a second brake portion 22, a solenoid 23, and an elastic portion 24. The brake device 20 is accommodated inside the cover portion 50. The first brake portion 21, the second brake portion 22, the solenoid 23, and the elastic portion 24 are accommodated inside the cover portion 50.

Since the brake device 20 is accommodated inside the cover portion 50 in which the motor portion 30 is accommodated, it is not necessary to separately provide a space for accommodating the brake device 20. Therefore, the electric actuator 1 can be downsized by suppressing an increase in size particularly due to an increase in axial dimension.

The first brake portion 21 has a circumferential length opposing a portion of the peripheral wall portion 51. The first brake portion 21 has an arc shape along the peripheral wall portion 51. The first brake portion 21 is a magnetic material. The outer diameter of the outer peripheral surface of the first brake portion 21 is smaller than the inner diameter of the outer peripheral wall 52. The inner diameter of the inner peripheral surface of the first brake portion 21 is larger than the outer diameter of the inner peripheral wall 53. The first brake portion 21 includes a projecting portion 25, recesses 61A and 61B, recesses 62A and 62B, a hole 63, and a shaft 64.

The projecting portion 25 protrudes to the right side in the axial direction. The projecting portion 25 is located at the center of the first brake portion 21 in the circumferential direction. The projecting portion 25 is located at the radially inner end of the first brake portion 21. The projecting portion 25 has a rectangular shape extending in the circumferential direction when viewed in the axial direction. The projecting portion 25 may have a circular shape or the like when viewed in the axial direction. The projecting portion 25 can be provided in the first brake portion 21 by cutting, press-fitting, or the like.

The recesses 61A and 61B are provided at positions in the circumferential direction of the guide walls 56A and 56B. The recesses 62A and 62B are provided at positions in the circumferential direction of the guide walls 57A and 57B. The recesses 61A and 62A are recessed radially inward from the outer peripheral surface of the first brake portion 21. The recesses 61B and 62B are recessed radially outward from the inner peripheral surface of the first brake portion 21. The recess 61A is fitted to the guide wall 56A from the right side in the axial direction. The recess 61B is fitted to the guide wall 56B from the right side in the axial direction. The recess 62A is fitted to the guide wall 57A from the right side in the axial direction. The recess 62B is fitted to the guide wall 57B from the right side in the axial direction. The first brake portion 21 in which the recesses 61A and 61B and the recesses 62A and 62B are fitted to the guide walls 56A and 56B and the guide walls 57A and 57B, respectively, is guided by the guide walls 56A and 56B and the guide walls 57A and 57B to be movable in the axial direction in the state of being positioned in the cover portion 50 in the circumferential direction.

The hole 63 penetrates the first brake portion 21 in the axial direction. The holes 63 are provided symmetrically on one side and the other side in the circumferential direction with respect to the center in the circumferential direction of the first brake portion 21. The hole 63 located on one side in the circumferential direction is located outside the recesses 61A and 61B in the circumferential direction. The hole 63 located on the other side in the circumferential direction is located outside the recesses 62A and 62B in the circumferential direction. The radial position of the hole 63 is the radial center of the first brake portion 21.

The shaft 64 is arranged to extend in an axial direction. The shaft 64 is fixed by press-fitting the distal end on the right side in the axial direction into the hole 63. In the shaft 64 in which the right distal end is press-fitted to the hole 63, the left side in the axial direction protrudes from the first brake portion 21 to the left side in the axial direction and extends. In addition to the configuration in which the shaft 64 is press-fitted to the first brake portion 21, the shaft may be provided in the first brake portion 21 by shaving.

The elastic portion 24 is a coil spring. The elastic portion 24 is a compression spring. The elastic portion 24 is located on the left side in the axial direction of the first brake portion 21. The shaft 64 protruding from the first brake portion 21 is inserted into the elastic portion 24. The left end portion in the axial direction of the elastic portion 24 is in contact with the peripheral wall portion 51 from the right side in the axial direction. The right end portion in the axial direction of the elastic portion 24 is in contact with the first brake portion 21 from the left side in the axial direction. The elastic portion 24 whose left end portion in the axial direction is in contact with the peripheral wall portion 51 pushes the first brake portion 21 to the right in the axial direction by the elastic restoring force. Since the hole 63 and the shaft are provided symmetrically with respect to the circumferential center of the first brake portion 21, the elastic portion 24 can stably push the first brake portion 21 to the right side in the axial direction in a balanced state without being biased in the circumferential direction.

As illustrated in FIGS. 3 and 4, the solenoid 23 includes a coil 23A and a case 23B. The case 23B has a cylindrical shape that opens to the right side in the axial direction. The coil 23A is wound and accommodated in the case 23B. The case 23B is fixed between the holding wall 55A and the holding wall 55B in the peripheral wall portion 51. As an example, the case 23B is fixed to the right surface in the axial direction of the peripheral wall portion 51 using an epoxy adhesive. One solenoid 23 is located to oppose the first brake portion 21 in the axial direction. The first brake portion 21 is located on the right side in the axial direction of the solenoid 23.

The solenoid 23 pulls the first brake portion 21, which is a magnetic material located to oppose the first brake portion, to the left side in the axial direction against the force that the elastic portion 24 pushes due to the elastic restoring force by the electromagnetic force generated when the coil 23A is energized. In the solenoid 23, when the energization to the coil 23A is stopped and the energization is not performed, the electromagnetic force for pulling the first brake portion 21 is lost. As the electromagnetic force by the solenoid 23 is lost, the first brake portion 21 is pushed to the right side in the axial direction by the elastic restoring force of the elastic portion 24. Therefore, the solenoid 23 can switch the position of the first brake portion 21 between a non-braking position to be described later pulled to the left side in the axial direction by the electromagnetic force and a braking position pushed to the right side in the axial direction by the elastic restoring force of the elastic portion 24 according to the energized state.

The second brake portion 22 rotates in synchronization with the rotors 31 and 32. As illustrated in FIG. 2, the second brake portion 22 includes a tooth portion 26B and a protrusion 26C. The tooth portion 26B is located on the outer periphery which is an outer end portion in the radial direction of the second brake portion 22 with a plurality of (six in FIG. 2) gaps 26A interposed therebetween. That is, in the second brake portion 22, the gap 26A and the tooth portion 26B are alternately arranged on the outer periphery over the entire circumference. The radial positions of the gap 26A and the tooth portion 26B are positions overlapping with the projecting portion 25.

The protrusion 26C protrudes radially inward from an inner peripheral surface 22a of the second brake portion 22. A plurality of (four in FIG. 2) protrusions 26C are arranged at intervals in the circumferential direction. The inner peripheral surface 22a of the second brake portion 22 is fitted to an outer peripheral surface 33c of the right end portion in the axial direction of the motor shaft 33. The motor shaft 33 has a recess 33d recessed radially inward from the outer peripheral surface 33c. A plurality of (four in FIG. 2) recesses 33d are arranged at intervals in the circumferential direction. The protrusion 26C of the second brake portion 22 is fitted to the recess 33d of the motor shaft 33. The second brake portion 22 in which the protrusion 26C is fitted to the recess 33d is positioned in the circumferential direction with respect to the motor shaft 33. The second brake portion 22 is fixed in close contact with the left side of the rotor core 31A in the axial direction. The second brake portion 22 positioned in the circumferential direction with respect to the motor shaft 33 and fixed to the rotor core 31A rotates integrally in synchronization with the rotor core 31A, the rotor core 32A, and the motor shaft 33.

The position of the first brake portion 21 in the axial direction when the electromagnetic force by the solenoid 23 is lost and pushed by the elastic restoring force of the elastic portion 24 is a braking position where the projecting portion 25 overlaps with the gap 26A or the tooth portion 26B to brake the rotation of the rotor 31 as illustrated in FIG. 4. As illustrated in FIG. 3, the position of the first brake portion 21 in the axial direction when pulled by the electromagnetic force of the solenoid 23 is a non-braking position where the projecting portion 25 is separated to the left side from the braking position. The first brake portion 21 is movable in the axial direction between the braking position and the non-braking position. That is, the second brake portion 22 comes into contact with the first brake portion 21 at the braking position and does not come into contact with the first brake portion 21 at the non-braking position.

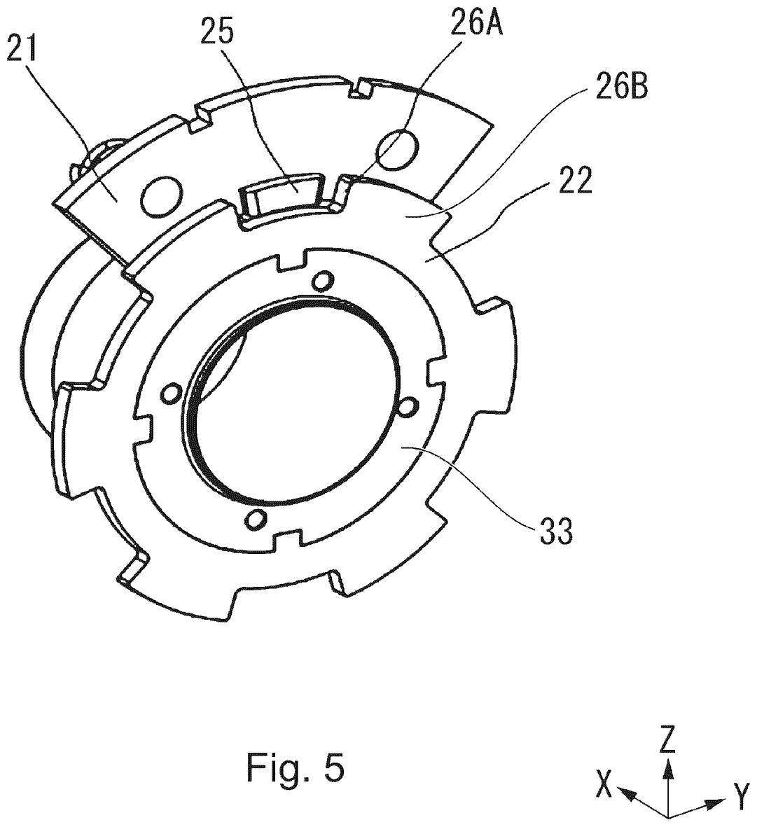

Therefore, while power is supplied, the first brake portion 21 is at the non-braking position in a non-contact manner with the second brake portion 22 by the electromagnetic force of the solenoid 23, and the rotation of the rotors 31 and 32 can transmit the decelerated rotation to the equipment connected to the output flange 11. On the other hand, when the supply of power is stopped, the electromagnetic force by the solenoid 23 is lost, so that the first brake portion 21 is pushed and moved to the right side in the axial direction by the elastic restoring force of the elastic portion 24, and is switched to the braking position in contact with the second brake portion 22. As illustrated in FIG. 5, in the first brake portion 21 at the braking position, since the projecting portion 25 is located in the gap 26A on the rotation path of the tooth portion 26B, the tooth portion 26B interferes with the projecting portion 25, so that the rotation of the rotors 31 and 32 is braked and stopped. As a result, the rotation transmission to the equipment connected to the output flange 11 can be stopped.

As described above, in the electric actuator 1 of the present example embodiment, the reduction gear 10, the brake device 20, the motor portion 30, and the position detector 40 are sequentially arranged along the axial direction, and the brake device 20 is accommodated in the cover portion 50 accommodating the motor portion 30. Therefore, it is not necessary to separately provide a cover or the like for accommodating the brake device 20, and downsizing and cost reduction can be realized.

In the electric actuator 1 of the present example embodiment, since the first brake portion 21 moves in the axial direction by being guided by the guide walls 56A and 56B provided on the cover portion 50 and the guide walls 57A and 57B, it is not necessary to separately provide a guide member, and further downsizing and cost reduction can be realized. Further, in the electric actuator 1 of the present example embodiment, since the rotation of the rotor 31 is braked by one solenoid 23 disposed at a specific position in the peripheral wall portion 51, it is possible to contribute to further miniaturization.

In the electric actuator 1 of the present example embodiment, since the projecting portion 25 is positioned at the braking position on the rotation path of the tooth portion 26B, the rotation of the rotor 31 can be quickly braked to improve the safety, and for example, the electric actuator 1 can be suitably used for a motor for low-speed operation, a joint of a drive unit in a robot arm, and the like.

In the above example embodiment, the configuration in which the brake device 20 includes one arc-shaped first brake portion 21 and one arc-shaped solenoid 23 has been exemplified. However, the present disclosure is not limited to this configuration, and a plurality of arc-shaped first brake portions 21 and a plurality of arc-shaped solenoids 23 may be provided.

### Second Example Embodiment of Brake Device

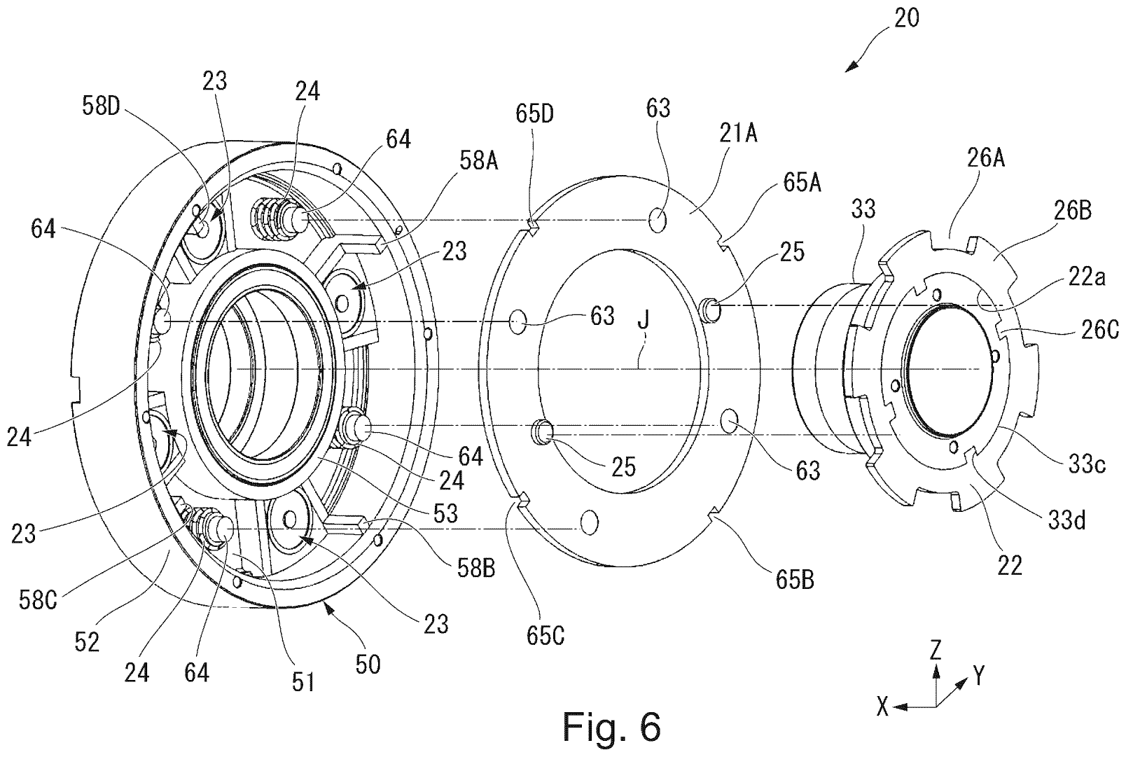

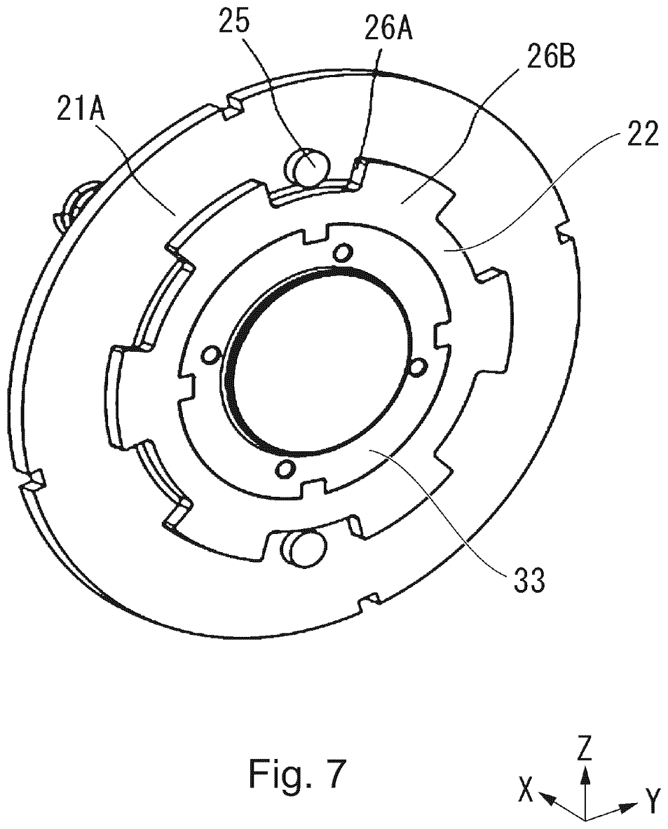

A second example embodiment of the brake device 20 will be described with reference to FIGS. 6 and 7.

In these drawings, the same elements as those of the first example embodiment illustrated in FIGS. 1 to 5 are denoted by the same reference numerals, and the description thereof will be omitted.

As illustrated in FIG. 6, a first brake portion 21A in the electric actuator 1 of the present example embodiment is provided in an annular shape over the entire circumference. A plurality of solenoids 23 are arranged at intervals in the circumferential direction at positions opposing the first brake portion 21A. Four solenoids 23 are provided at intervals of 90° in the circumferential direction. Four elastic portions 24 are disposed between the solenoids 23 in the circumferential direction. Guide walls 58A, 58B, 58C, and 58D of the cover portion 50 are provided at intervals of 90° in the circumferential direction.

In the present example embodiment, the projecting portion 25 of the first brake portion 21A is a circular pin as viewed in the axial direction. As in the first example embodiment, the projecting portion 25 may have a rectangular shape extending in the circumferential direction. The projecting portion 25 is provided in the first brake portion 21A by press fitting, for example. Two projecting portions 25 are provided at intervals of 180° in the circumferential direction. The outer peripheral surface of the first brake portion 21A has recesses 65A, 65B, 65C, and 65D. The recesses 65A, 65B, 65C, and 65D are recessed radially inward from the outer peripheral surface of the first brake portion 21A. The recesses 65A, 65B, 65C, and 65D are provided at intervals of 90° in the circumferential direction. The recesses 65A, 65B, 65C, and 65D are respectively fitted to the guide walls 58A, 58B, 58C, and 58D from the right side in the axial direction. The first brake portion 21A in which the recesses 65A, 65B, 65C, and 65D are fitted to the guide walls 58A, 58B, 58C, and 58D, respectively, is guided by the guide walls 58A, 58B, 58C, and 58D to be movable in the axial direction in the state of being circumferentially positioned by the cover portion 50.

Other configurations are the same as those of the first example embodiment.

In the electric actuator 1 having the above configuration, while power is supplied, the first brake portion 21A is held at the non-braking position by the electromagnetic force of the four solenoids 23. On the other hand, when the supply of power is stopped, the electromagnetic force by the four solenoids 23 is lost, so that the first brake portion 21A is pushed and moved to the right side in the axial direction by the elastic restoring force of the four elastic portions 24 and is switched to the braking position. As illustrated in FIG. 7, in the first brake portion 21A at the braking position, since the two projecting portions 25 are located in the gap 26A on the rotation path of the tooth portion 26B, the tooth portion 26B interferes with the two projecting portions 25, so that the rotation of the rotors 31 and 32 is braked and stopped. As a result, the rotation transmission to the equipment connected to the output flange 11 can be stopped.

In the electric actuator 1 of the present example embodiment, in addition to obtaining the same operation and effect as those of the first example embodiment, the rotation of the rotors 31 and 32 is braked by the two projecting portions 25 in the first brake portion 21A, and thus, the electric actuator 1 can be suitably used for an electric actuator requiring a large lock torque.

### Third Example Embodiment of Brake Device

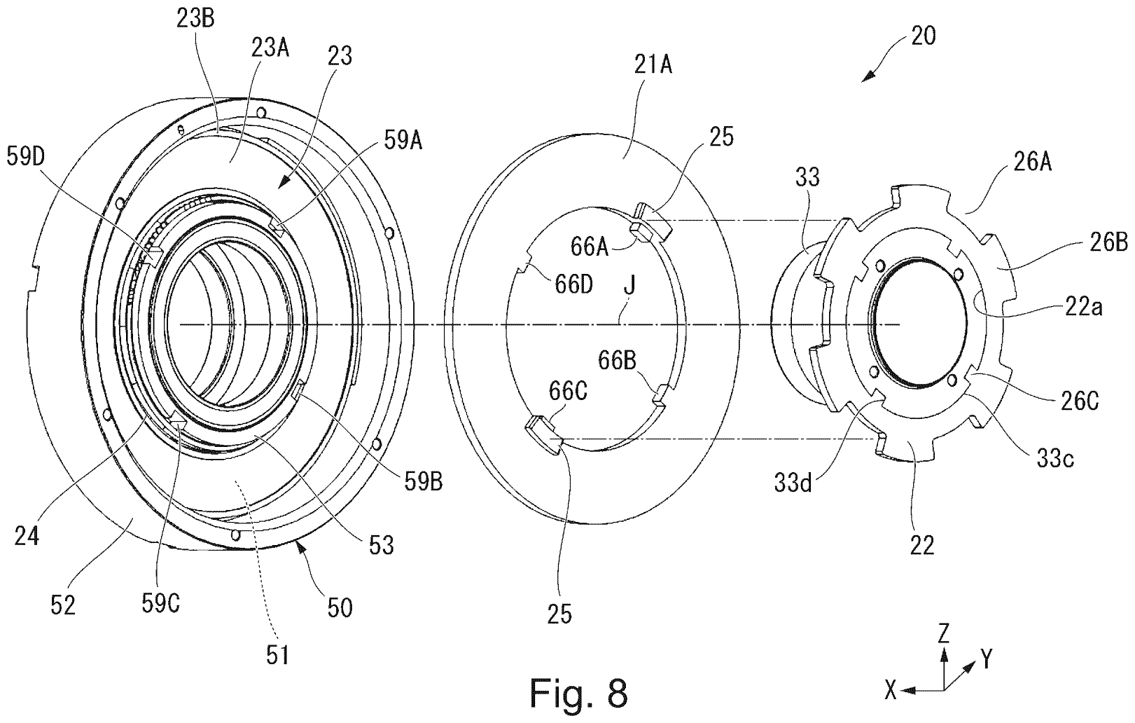

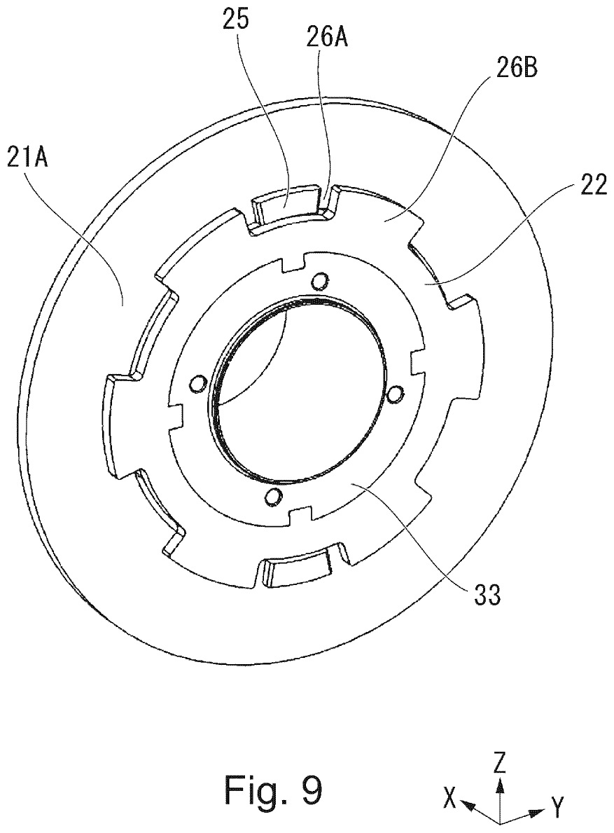

A third example embodiment of the brake device 20 will be described with reference to FIGS. 8 and 9.

In these drawings, the same elements as those of the second example embodiment illustrated in FIGS. 6 and 7 are denoted by the same reference numerals, and the description thereof will be omitted.

As illustrated in FIG. 8, the solenoid 23 in the electric actuator 1 of the present example embodiment is annularly disposed over the entire circumference at a position where the coil 23A and the case 23B face the first brake portion 21A in the axial direction.

The inner peripheral wall 53 of the cover portion 50 has guide groove portions 59A, 59B, 59B, and 59D. Each of the guide groove portions 59A, 59B, 59B, and 59D is recessed radially inward from the outer peripheral surface of the inner peripheral wall 53. Each of the guide groove portions 59A, 59B, 59B, and 59D extends in the axial direction and opens on the right end surface of the inner peripheral wall 53 in the axial direction. The guide groove portions 59A, 59B, 59B, and 59D are arranged at intervals of 90° in the circumferential direction. In the inner peripheral wall 53, the elastic portion 24 is inserted. The elastic portion 24 is disposed radially outside the inner peripheral wall 53 about the central axis J.

As in the first example embodiment, the projecting portion 25 of the first brake portion 21A has a rectangular shape extending in the circumferential direction. The first brake portion 21A has protrusions 66A, 66B, 66C, and 66D. The protrusions 66A, 66B, 66C, and 66D protrude radially inward from the inner peripheral surface of the first brake portion 21A. The protrusions 66A, 66B, 66C, and 66D are arranged at intervals of 90° in the circumferential direction. The protrusions 66A, 66B, 66C, and 66D are fitted to the guide groove portions 59A, 59B, 59B, and 59D, respectively, from the right side in the axial direction. The first brake portion 21A in which the protrusions 66A, 66B, 66C, and 66D are fitted to the guide groove portions 59A, 59B, 59B, and 59D, respectively, is guided by the guide groove portions 59A, 59B, 59B, and 59D to be movable in the axial direction in the state of being circumferentially positioned by the cover portion 50.

Other configurations are the same as those of the second example embodiment.

In the electric actuator 1 having the above configuration, while power is supplied, the first brake portion 21A is held at the non-braking position by the electromagnetic force of the solenoid 23. On the other hand, when the supply of power is stopped, the electromagnetic force by the solenoid 23 is lost, so that the first brake portion 21A is pushed and moved to the right side in the axial direction by the elastic restoring force of the elastic portion 24 and is switched to the braking position. As illustrated in FIG. 9, in the first brake portion 21A at the braking position, since the two projecting portions 25 are located in the gap 26A on the rotation path of the tooth portion 26B, the tooth portion 26B interferes with the two projecting portions 25, so that the rotation of the rotors 31 and 32 is braked and stopped. As a result, the rotation transmission to the equipment connected to the output flange 11 can be stopped.

In the electric actuator 1 of the present example embodiment, it is possible to realize cost reduction by reducing the number of solenoids 23 in addition to obtaining the same operation and effect as those of the second example embodiment.

### Fourth Example Embodiment of Brake Device

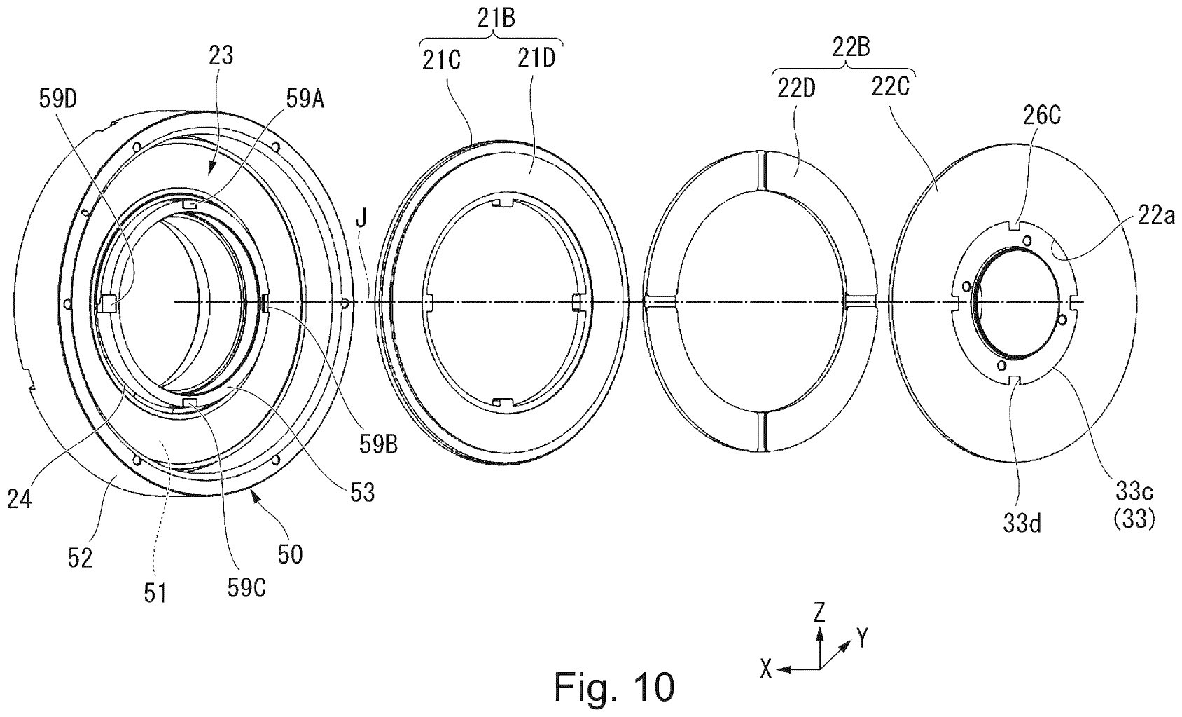

A fourth example embodiment of the brake device 20 will be described with reference to FIGS. 10 to 14.

In these drawings, the same elements as those of the third example embodiment illustrated in FIGS. 8 and 9 are denoted by the same reference numerals, and the description thereof will be omitted.

As illustrated in FIG. 10, a first brake portion 21B in the electric actuator 1 of the present example embodiment includes a disk portion 21C and a first brake pad 21D. A second brake portion 22B in the electric actuator 1 of the present example embodiment includes a disk portion 22C and a second brake pad 22D.

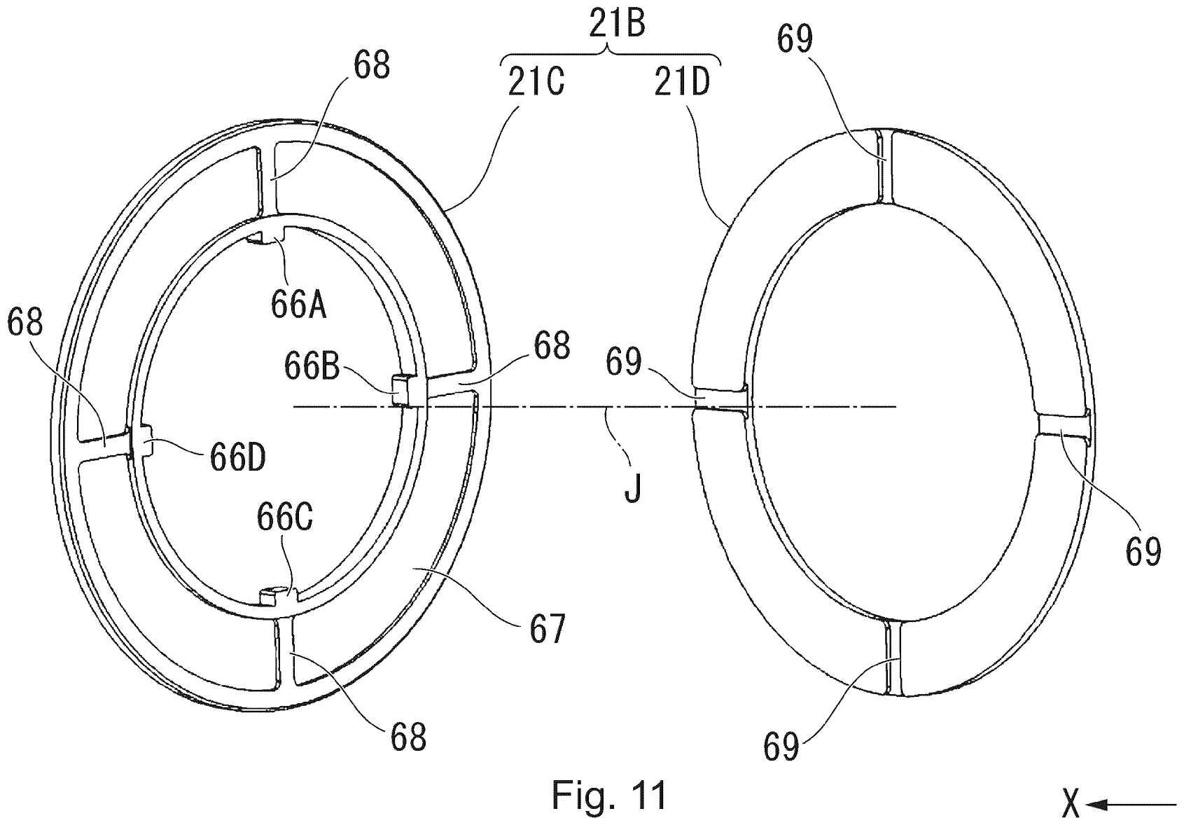

As illustrated in FIG. 11, the disk portion 21C is provided in an annular shape over the entire circumference. The disk portion 21C has a groove portion 67, a rib 68, and protrusions 66A, 66B, 66C, and 66D. The groove portion 67 is recessed from the right side surface in the axial direction of the disk portion 21C to the left side. The groove portion 67 has an annular shape over the entire circumference. The groove portion 67 is provided away from the outer peripheral surface and the inner peripheral surface of the disk portion 21C. The rib 68 protrudes to the right side in the axial direction from the bottom of the groove portion 67. The rib 68 extends in the radial direction. Four ribs 68 are provided at intervals of 90° in the circumferential direction.

The protrusions 66A, 66B, 66C, and 66D protrude radially inward from the inner peripheral surface of the disk portion 21C. The protrusions 66A, 66B, 66C, and 66D are respectively fitted to the guide groove portions 59A, 59B, 59B, and 59D of the cover portion 50 from the right side in the axial direction. The disk portion 21C in which the protrusions 66A, 66B, 66C, and 66D are fitted to the guide groove portions 59A, 59B, 59B, and 59D, respectively, is guided by the guide groove portions 59A, 59B, 59B, and 59D to be movable in the axial direction in the state of being circumferentially positioned by the cover portion 50.

The first brake pad 21D is provided in an annular shape over the entire circumference. The first brake pad 21D is inserted into the groove portion 67 of the disk portion 21C from the right side in the axial direction and fixed using an adhesive. The first brake pad 21D is provided opposing the right side in the axial direction in the first brake portion 21B. The first brake pad 21D has a groove portion 69.

The groove portion 69 is recessed rightward from the surface on the left side in the axial direction of the first brake pad 21D. The groove portion 69 extends in the radial direction and opens on the outer peripheral surface and the inner peripheral surface of the first brake pad 21D, respectively. Four groove portions 69 are provided at intervals of 90° in the circumferential direction. The groove portion 69 is fitted to the rib 68 in the circumferential direction when the first brake pad 21D is inserted into the groove portion 67 in the disk portion 21C. The first brake pad 21D in which the groove portion 69 is fitted to the rib 68 in the circumferential direction is positioned in the circumferential direction with respect to the cover portion 50 via the disk portion 21C. The first brake pad 21D is positioned in the circumferential direction with respect to the cover portion 50, thereby restricting the rotation in the circumferential direction.

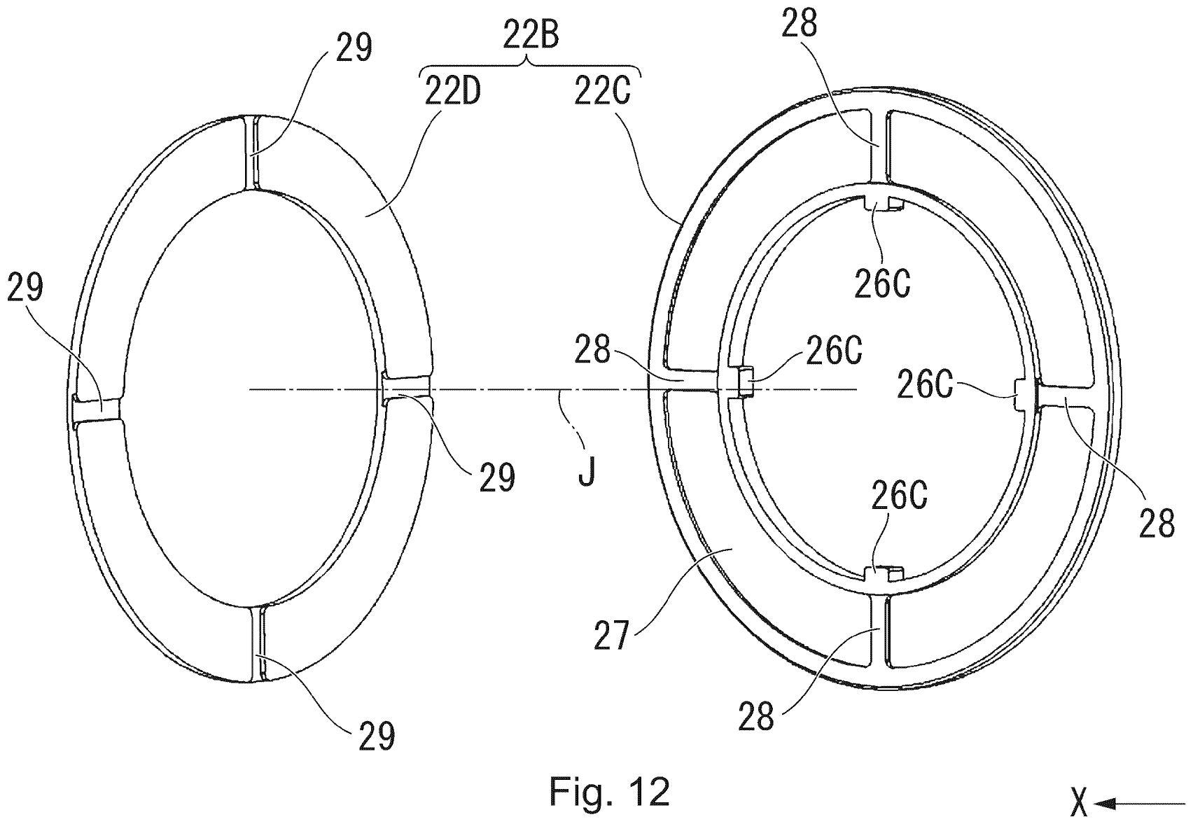

As illustrated in FIG. 12, the disk portion 22C is provided in an annular shape over the entire circumference. The disk portion 22C has a groove portion 27, a rib 28, and a protrusion 26C. The groove portion 27 is recessed rightward from the surface on the left side in the axial direction of the disk portion 22C. The groove portion 27 has an annular shape over the entire circumference. The groove portion 27 is provided away from the outer peripheral surface and the inner peripheral surface of the disk portion 22C. The rib 28 protrudes to the left side in the axial direction from the bottom of the groove portion 27. The rib 28 extends in the radial direction. Four ribs 28 are provided at intervals of 90° in the circumferential direction.

The second brake pad 22D is provided in an annular shape over the entire circumference. The second brake pad 22D is inserted into the groove portion 27 of the disk portion 22C from the left side in the axial direction and fixed using an adhesive. The second brake pad 22D is provided opposing the left side in the axial direction in the second brake portion 22B. The second brake pad 22D has a groove portion 29.

The groove portion 29 is recessed to the left from the right side surface in the axial direction of the second brake pad 22D.

The groove portion 29 extends in the radial direction and opens on the outer peripheral surface and the inner peripheral surface of the second brake pad 22D, respectively. Four groove portions 29 are provided at intervals of 90° in the circumferential direction. The groove portion 29 is fitted to the rib 28 in the circumferential direction when the second brake pad 22D is inserted into the groove portion 27 in the disk portion 22C. The second brake pad 22D in which the groove portion 29 is fitted to the rib 28 in the circumferential direction is positioned in the circumferential direction with respect to the motor shaft 33 via the disk portion 22C. The second brake pad 22D is positioned in the circumferential direction with respect to the motor shaft 33 to rotate in synchronization with the rotors 31 and 32.

As the materials of the first brake pad 21D and the second brake pad 22D, the same type of material as a known brake pad can be used. Materials of the first brake pad 21D and the second brake pad 22D are, for example, a structure in which a friction material is provided on a base material. As the friction material, a resin-based material obtained by solidifying metal powder or fiber material with resin, or a metal-based material obtained by sintering metal powder can be used.

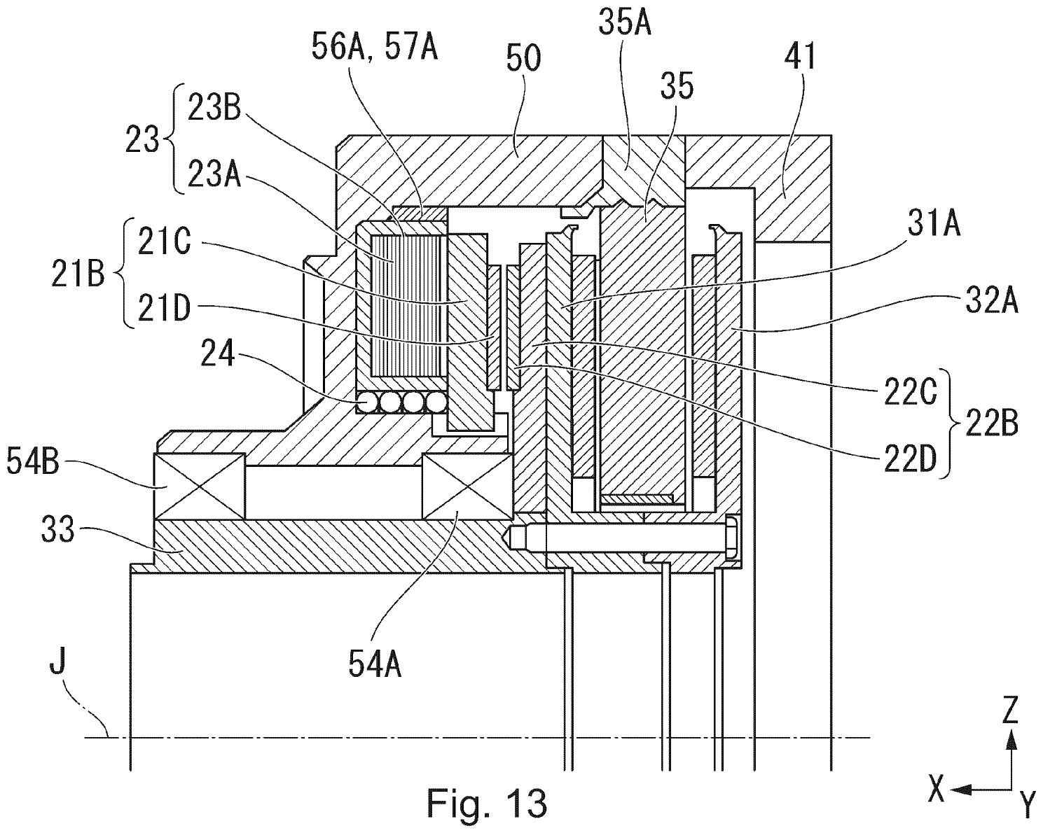

In the electric actuator 1 having the above configuration, while power is supplied, the first brake portion 21B is held at the non-braking position where the first brake pad 21D is separated to the left side in the axial direction with respect to the second brake pad 22D by the disk portion 21C moving to the left side in the axial direction as illustrated in FIG. 13 by the electromagnetic force of the solenoid 23.

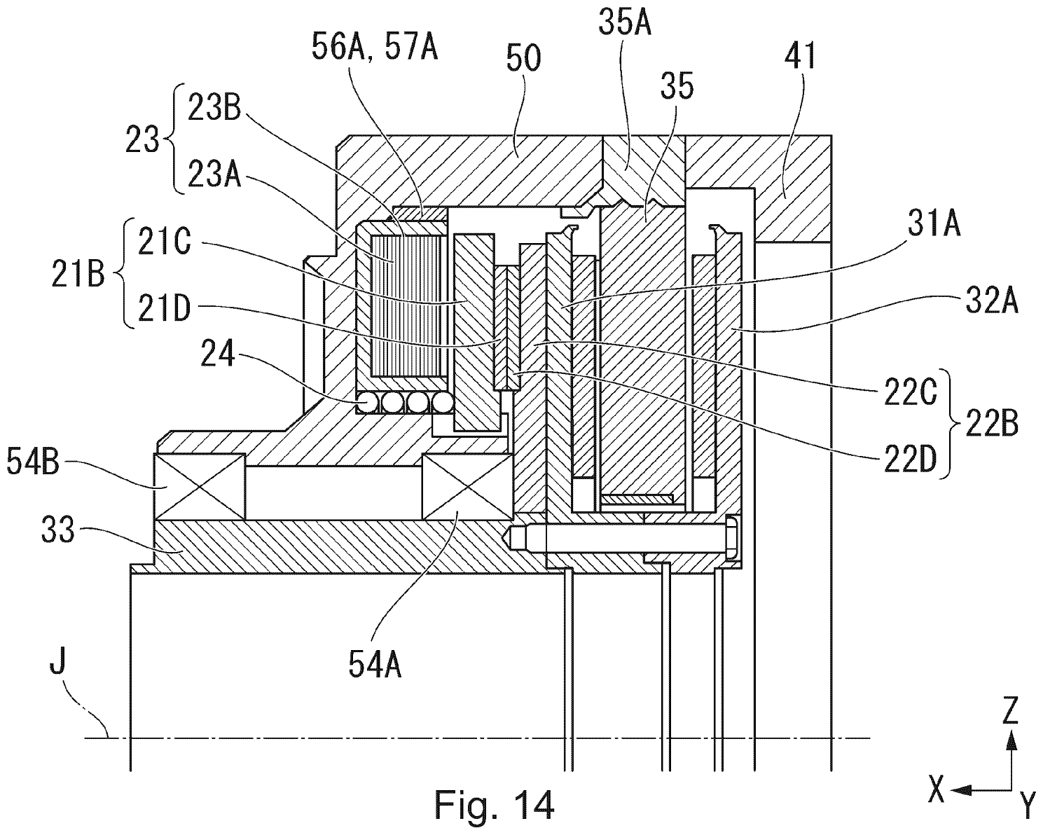

On the other hand, when the supply of power is stopped, the electromagnetic force by the solenoid 23 is lost, and thus, in the first brake portion 21B, the first brake pad 21D is pushed and moved to the right side in the axial direction via the disk portion 21C by the elastic restoring force of the elastic portion 24, and is switched to the braking position. As illustrated in FIG. 14, in a state where the first brake portion 21B at the braking position is pressed by the elastic restoring force of the elastic portion 24, the first brake pad 21D comes into surface contact with the second brake pad 22D. The second brake pad 22D that rotates in synchronization with the rotors 31 and 32 is braked by the frictional force accompanying the surface contact with the first brake pad 21D, decelerated, and then stopped. As a result, the rotation transmission to the equipment connected to the output flange 11 can be stopped.

In the electric actuator 1 of the present example embodiment, in addition to obtaining the same operation and effect as those of the third example embodiment, it is possible to suppress an impact generated when the rotors 31 and 32 stop rotating by decelerating and then stopping the rotation of the rotors 31 and 32 for braking using frictional force. Therefore, it can be suitably used for an electric actuator having the motor portion 30 that rotates at a high speed.

In the brake device 20 of the fourth example embodiment, the configuration in which the coil 23A and the case 23B in the solenoid 23 are annularly arranged over the entire circumference at positions opposing the first brake portion 21B in the axial direction has been exemplified, but the present disclosure is not limited to this configuration. For example, as illustrated in FIG. 6 in the second example embodiment, a plurality of solenoids 23 may be arranged at positions opposing the first brake portion 21B at intervals in the circumferential direction.

While the example embodiments of the present disclosure have been described above with reference to the accompanying drawings, it is obvious that the present disclosure is not limited to the example embodiments. Various shapes, combinations, and the like of the constituent members in the above example embodiments are only by way of example, and various modifications are possible based on design requirements and the like without departing from the gist of the present disclosure.

For example, in the above example embodiment, the configuration in which the rotors 31 and 32 and the stator 35 in the motor portion 30 are axial gap motors facing each other with a gap interposed therebetween in the axial direction has been exemplified, but the present disclosure is not limited to this configuration. The motor portion 30 may be a radial gap motor in which the rotor and the stator face each other in the radial direction with a gap interposed therebetween.

In a case where the motor portion 30 is a radial gap motor, the second brake portion may be provided at a position opposing the first brake portion in the axial direction in the rotor.

In addition, the shape of the projecting portion 25 of the first brake portion 21 exemplified in the above example embodiment is an example, and other shapes may be used as long as the rotation of the second brake portion 22 can be braked.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-9. (canceled)

10: An electric actuator comprising:
a motor portion that includes a rotor rotatable about a motor shaft extending in an axial direction, and a stator opposing the rotor with a gap interposed therebetween;
a reduction gear to decelerate and output rotation of the rotor;
a brake to brake rotation of the rotor;
a position detector to detect a position change of the rotor; and
a cover that is located on one side in the axial direction of the motor portion and accommodates the motor portion inside; wherein
the reduction gear, the brake, the motor portion, and the position detector are sequentially arranged in the axial direction from one side in the axial direction;
the brake includes:
a first brake portion including a magnetic material located on one side in the axial direction of the rotor, the first brake portion being movable in the axial direction between a braking position for braking rotation of the rotor and a non-braking position away from the braking position toward one side in the axial direction;
a second brake portion that rotates in synchronization with the rotor, is in contact with the first brake portion at the braking position, and is in non-contact with the first brake portion at the non-braking position; and
a solenoid that switches a position of the first brake portion between the braking position and the non-braking position according to an energized state; and
the brake is accommodated inside the cover.

11: The electric actuator according to claim 10, further comprising an elastic portion that pushes the first brake portion toward another side in the axial direction; wherein
the first brake portion is operable to:
be located at the non-braking position against a pushing force of the elastic portion when the solenoid is energized; and
be located at the braking position by the pushing force of the elastic portion when the solenoid is not energized.

12: The electric actuator according to claim 10, wherein
the cover includes:
an annular peripheral wall portion that is orthogonal to the axial direction and extends in a circumferential direction around the axial direction;
an outer peripheral wall extending from an outer edge of the peripheral wall portion to the other side in the axial direction over an entire circumference; and
an inner peripheral wall extending from an inner edge of the peripheral wall portion to the other side in the axial direction over an entire circumference;
the solenoid is fixed to another side of the peripheral wall portion in the axial direction; and
the first brake portion is located on another side in the axial direction of the solenoid.

13: The electric actuator according to claim 11, wherein
the cover includes:
an annular peripheral wall portion that is orthogonal to the axial direction and extends in a circumferential direction around the axial direction;
an outer peripheral wall extending from an outer edge of the peripheral wall portion to the other side in the axial direction over an entire circumference; and
an inner peripheral wall extending from an inner edge of the peripheral wall portion to the other side in the axial direction over an entire circumference;
the solenoid is fixed to another side of the peripheral wall portion in the axial direction; and
the first brake portion is located on another side in the axial direction of the solenoid.

14: The electric actuator according to claim 12, wherein
the first brake portion has a length in the circumferential direction opposing a portion of the peripheral wall portion; and
the solenoid is located to oppose the first brake portion.

15: The electric actuator according to claim 13, wherein
the first brake portion has a length in the circumferential direction opposing a portion of the peripheral wall portion; and
the solenoid is located to oppose the first brake portion.

16: The electric actuator according to claim 12, wherein
the first brake portion is provided in an annular shape over an entire circumference; and
a plurality of the solenoids are arranged at positions opposing the first brake portion at intervals in a circumferential direction.

17: The electric actuator according to claim 13, wherein
the first brake portion has an annular shape over an entire circumference; and
a plurality of the solenoids are arranged at positions opposing the first brake portion at intervals in a circumferential direction.

18: The electric actuator according to claim 12, wherein
the first brake portion has an annular shape over an entire circumference;
the solenoid includes a coil wound in a circumferential direction and a case accommodating the coil; and
the coil and the case are annularly arranged over an entire circumference at positions opposing the first brake portion in the axial direction.

19: The electric actuator according to claim 13, wherein
the first brake portion has an annular shape over an entire circumference;
the solenoid includes a coil wound in a circumferential direction and a case accommodating the coil; and
the coil and the case are annularly arranged over an entire circumference at positions opposing the first brake portion in the axial direction.

20: The electric actuator according to claim 10, wherein
the first brake portion includes a projecting portion protruding to the other side in the axial direction;
in the second brake portion, a gap and a tooth portion are alternately arranged on an outer periphery over an entire circumference; and
radial positions of the gap and the tooth portion are positions overlapping the projecting portion at the braking position.

21: The electric actuator according to claim 11, wherein
the first brake portion includes a projecting portion protruding to the other side in the axial direction;
in the second brake portion, a gap and a tooth portion are alternately arranged on an outer periphery over an entire circumference; and
radial positions of the gap and the tooth portion are positions overlapping the projecting portion at the braking position.

22: The electric actuator according to claim 12, wherein
the first brake portion includes a projecting portion protruding to the other side in the axial direction;
in the second brake portion, a gap and a tooth portion are alternately arranged on an outer periphery over an entire circumference; and
radial positions of the gap and the tooth portion are positions overlapping the projecting portion at the braking position.

23: The electric actuator according to claim 13, wherein
the first brake portion includes a projecting portion protruding to the other side in the axial direction;
in the second brake portion, a gap and a tooth portion are alternately arranged on an outer periphery over an entire circumference; and
radial positions of the gap and the tooth portion are positions overlapping the projecting portion at the braking position.

24: The electric actuator according to claim 10, wherein
the first brake portion includes a first brake pad opposing the other side in the axial direction; and
the second brake portion includes a second brake pad in surface contact with the first brake pad at the braking position.

25: The electric actuator according to claim 11, wherein
the first brake portion includes a first brake pad opposing the other side in the axial direction; and
the second brake portion includes a second brake pad in surface contact with the first brake pad at the braking position.

26: The electric actuator according to claim 12, wherein
the first brake portion includes a first brake pad opposing the other side in the axial direction; and
the second brake portion includes a second brake pad in surface contact with the first brake pad at the braking position.

27: The electric actuator according to claim 13, wherein
the first brake portion includes a first brake pad opposing the other side in the axial direction; and
the second brake portion includes a second brake pad in surface contact with the first brake pad at the braking position.

28: The electric actuator according to claim 10, wherein the rotor and the stator oppose each other in the axial direction with a gap interposed therebetween.

29: The electric actuator according to claim 13, wherein the rotor and the stator oppose each other in the axial direction with a gap interposed therebetween.
